(19) United States
(12) Patent Application Publication
(10) Pub. No.: US 2015/0105506 A1
(43) Pub. Date: Apr. 16, 2015

(54) THERMOPLASTIC MOULDING COMPOUNDS

(71) Applicant: LANXESS Deutschland GmbH, Cologne (DE)

(72) Inventors: Tobias BENIGHAUS, Muenster (DE); Detlev JOACHIMI, Krefeld (DE); Richard WEIDER, Leverkusen (DE); Oliver WOLFF, Pulheim-Brauweiler (DE)

(21) Appl. No.: 14/513,664

(22) Filed: Oct. 14, 2014

(30) Foreign Application Priority Data
Oct. 15, 2013 (EP) 13188758.0

(51) Int. Cl. C08K 13/02

(52) U.S. Cl. CPC C08K 13/02
USPC 524/222; 106/483

(57) ABSTRACT

The present invention relates to mixtures for thermoplastic moulding compositions based on polyamides with the mineral filler triclinic pinacoidal aluminium silicate and with at least one heat stabilizer, and also at least one additional substance, to the production of these, and also to electrically insulating, thermally conductive products to be produced therefrom, in particular mouldings and semifinished products.

The present invention relates to mixtures for thermoplastic moulding compositions based on polyamides with the mineral filler the triclinic pinacoidal form of aluminium silicate and with at least one heat stabilizer, and also at least one additional substance, to the production of these, and also to electrically insulating, thermally conductive products to be produced therefrom, in particular mouldings and semifinished products.

### BACKGROUND OF THE INVENTION

Because thermoplastic polymers have good electrically insulating properties they are used for numerous applications in the electrical industry. However, they also have a thermally insulating effect, because of their low thermal conductivity, and this is problematic for electrical components when a relatively large amount of heat is produced and has to be dissipated. The electrical and thermal conductivity of thermoplastics can be modified widely by using additives: addition of, for example, graphite increases both electrical and thermal conductivity. However, there are only a few ways of increasing the thermal conductivity while retaining very low electrical conductivity of the type required for applications in the electrical industry.

The dissertation by Wolfgang Übler (University of Erlangen-Nuremberg, Publication of Jul. 17, 2004) on the topic of “Erhöhung der thermischen Leitfähigkeit elektrisch isolierender Polymerwerkstoffe” [Increasing the Thermal Conductivity of Electrically Insulating Polymer Materials] describes a process for filling casting resins with electrically insulating pulverulent filler components that have good thermal conductivity, the quantities of the filler components being such as to maximize the thermal conductivity of the resultant casting resin. This objective was achieved with commercially available ceramic powder fractions such as aluminium oxide, silicon carbide, boron nitride, powdered quartz and other quartz materials, these materials usually being used to produce grinding products. Addition of aluminium oxide (α-Al₂O₃) to increase the thermal conductivity of thermoplastic moulding compositions and products to be produced therefrom is known, and is described in many Patent Applications.

DE 102 60 098 A1 says that addition of aluminium oxide renders thermoplastic polyesters electrically insulating and thermally conductive. Other additional substances listed are low-molecular-weight and polymeric organic compounds.

WO 2003/051971 A2 relates to flexible compounded materials based on a thermoplastic elastomer, in particular based on polyamide with 72.3% by weight of aluminium oxide with thermal conductivity 1.1 W/mK at 40° C. for the production of thermally conductive hoses which can in particular be used as heating hose or cooling hose.

JP 2004 059638 A2, too, describes polyamide compositions with excellent properties in relation to thermal conductivity, heat resistance, low water absorption, and use in injection moulding. Examples are moreover disclosed on the basis of PA 6T, PA 9MT and PA 66 (PA=polyamide); the thermal conductivity additive Nippon Light Metal Manufacturing Alumina, “LS130” was added to these.

JP 2005 112908 A2 teaches the use of aluminium-oxide-filled polyamide as electrical insulator with good thermal conductivity. The products obtained are in particular described for the use of cable sheathing which remains functional for at least 50 hours when exposed to 2000 volts.

The use of graphite in compounded polyamide materials has been widely described, but the electrical conductivity of the resultant moulding compositions is the main point of interest.

DE 36 44 773 A1 describes polyamide resin compositions which comprise glass fibres and graphite; these achieve inherent surface resistance values extending as far as only 2.2.10⁴ Ω.

JP 2003 165904 A describes a graphite-containing, electrically conductive compounded polyamide material with particularly good impact resistance, which is achieved by adding rubber.

The polyamide- and graphite-based materials described in U.S. Pat. No. 6,228,288 are intended to be suitable for use for sensors on the basis of their electrical conductivity values.

JP 2007 016093 A describes a composition made of thermoplastic polymers and from 1 to 50% of graphite with improved thermal conductivity of 1.6 W/mK.

WO 2009/019186 A1 describes electrically insulating thermally conductive compounded polyamide materials which comprise both aluminium oxide and graphite.

Compounded polyamide materials are often used in applications subject to stringent mechanical requirements. Another important requirement placed upon compounded polyamide materials, alongside thermal conductivity and electrical resistance, is therefore good mechanical properties. However, the use of aluminium oxide and graphite in compounded polyamide materials in order to improve thermal conductivity causes significant embrittlement of the compounded material and of products to be produced therefrom. Compounded polyamide materials/polyamide products produced from moulding compositions with use of graphite and aluminium oxide have only a low level of performance in relation to resistance to deformation (tensile strain at break) and in relation to impact resistance. Tensile strain at break is a characteristic value of a material that states the permanent elongation of a specimen after fracture, divided by the initial measured length, and is therefore an essential index for characterizing the deformability (or ductility) of a material (http://de.wikipedia.org/wiki/Bruchdehnung).

In contrast, the impact resistance of a material describes its capability to absorb energy from shocks and impacts, without fracturing. Impact resistance is calculated as the ratio of impact energy to specimen cross section (unit of measurement kJ/m²). Impact resistance can be determined via various types of flexural impact test, Charpy according to ISO 179-1 or lzod according to ISO 180. For impact resistance, unlike notched impact resistance, the test specimen has no notch (see also: http://de.wikipedia.org/wiki/Schlagz%C3%A4higkeit or even “Schlagbiegeversuch (flexural impact test)”, PSM, Polymer Service GmbH Merseburg, under http://wiki.polymerservice-merseburg.de/index.php/Schlagbiegeversuch).

The use of graphite and aluminium oxide in compounded polyamide materials or in products produced therefrom results in low resistance to impact load. The use of graphite in industrial production plants is moreover not desirable. Because graphite has low density and particle size it easily forms dusts which are electrically conductive and can smoulder above 350° C. These properties cause risks to people and electronic equipment.

On the other hand, the use of aluminium oxide in the processing of compounded polyamide materials leads to increased wear of the equipment used, because of the hardness of the aluminium oxide. In the case of an extrusion process it is particularly the screw, barrel and die that are affected. In the case of the injection-moulding process, there is also a marked increase in wear on the injection mould.

Compounded polyamide materials with improved thermal conductivity are usually used in the vicinity of heat sources. Components made of these compounded polyamide materials are therefore frequently exposed to elevated temperatures.

Compounded polyamide materials and products to be produced therefrom generally exhibit impairment of their mechanical properties when they are exposed to elevated temperatures for a prolonged period. This effect is mainly caused by oxidative degradation of the polymer at elevated temperatures (thermooxidative degradation). For the purposes of the present invention, the expression prolonged period means longer than 100 hours, and for the purposes of the present invention the expression elevated temperatures means above 80° C.

The stability of thermoplastic moulding compositions and products to be produced therefrom with respect to thermooxidative degradation is usually assessed by taking a standardized test specimen as an example of a product and comparing mechanical properties, in particular impact resistance, the breaking stress and tensile strain at break measured in the ISO 527 tensile test, and also the modulus of elasticity at a defined temperature over a defined period.

It was therefore an object of the present invention to provide thermoplastic moulding compositions based on polyamide for the production of products which have high thermal conductivity and which at the same time feature electrically insulating properties and good mechanical properties, where significant impairment of mechanical properties by elevated temperatures occurs only after prolonged periods. The intention is moreover to avoid the abovementioned disadvantages associated with the use of aluminium oxide.

Surprisingly, it has been found that polyamide-based thermoplastic moulding compositions and products produced therefrom which also comprise, alongside aluminium silicate, at least one heat stabilizer feature increased thermal conductivity and good mechanical properties even after prolonged exposure to relatively high temperatures, without any occurrence of the abovementioned disadvantages in the processing of the said thermoplastic moulding compositions.

Surprisingly, it has moreover been found that there is a further increase in the thermal conductivity of polyamide-based thermoplastic moulding compositions and products produced therefrom with the triclinic pinacoidal form of aluminium silicate (kyanite) (Hermann-Mauguin notation system) when comparison is made with thermoplastic moulding compositions with the triclinic pedial form of aluminium silicate (kaolin).

### OBEJCT OF THE PRESENT INVENTION

The object is achieved by, and the invention therefore provides, mixtures for thermoplastic moulding compositions comprising
a. from 5 to 69.94% by weight of polyamide,
b. from 30 to 80% by weight of triclinic pinacoidal aluminium silicate,
c. from 0.05 to 5% by weight of at least one heat stabilizer and
d. from 0.01 to 60% by weight of at least one other additional substance,
   where the sum of all of the percentages by weight is always 100% by weight.

For clarification, it should be noted that the scope of this invention comprises any desired combination of all of the definitions and parameters listed below in general terms or in preferred ranges. It should moreover be noted that for the purposes of the present invention the simplified expression triclinic pinacoidal aluminium silicate, or kyanite, is used synonymously with the expression the triclinic pinacoidal form of aluminium silicate.

The mixtures of the invention are prepared for further use by mixing, in at least one mixer, the components a., b., c. and d. to be used as starting materials. This gives, as intermediate products, moulding compositions based on the mixtures of the invention. These moulding compositions—also termed thermoplastic moulding compositions—can either be composed exclusively of the components a., b., c. and d. or else can also comprise other components in addition to the components a., b., c. and d. In this case, for the purposes of the stated quantitative ranges, it is necessary to vary the components a., b., c. and d. in such a way that the sum of all of the percentages by weight is always 100.

The invention moreover provides polyamide moulding compositions intended for use in extrusion, in blow moulding or in injection moulding, preferably in pellet form, comprising the mixtures of the invention, which make up from 95 to 100% by weight, preferably from 98 to 100% by weight, particularly preferably from 99 to 100% by weight, of the polyamide moulding compositions of the invention or of the polyamide moulding compositions to be used in the invention for the production of electrically insulating but thermally conductive products.

### PREFERRED EMBODIMENTS OF THE PRESENT INVENTION

In one preferred embodiment, the mixtures of the invention for thermoplastic moulding compositions comprise from 40 to 80% by weight of the component b. triclinic pinacoidal aluminium silicate, particularly preferably from 50 to 80% by weight, very particularly preferably from 60 to 80% by weight.

The polyamides to be used as component a. are preferably amorphous or semicrystalline polyamides, particular preference being given to semicrystalline polyamides with a melting point of at least 180° C. or amorphous polyamides with a glass transition temperature of at least 150° C.

According to DE 10 2011 084 519 A1 ,the enthalpy of fusion of semicrystalline polyamides is from 4 to 25 J/g, measured by the DSC method in accordance with ISO 11357 in the 2^{nd} heating procedure with integration of the melting peak. In contrast, the enthalpy of fusion of amorphous polyamides is less than 4 J/g, measured by the DSC method in accordance with ISO 11357 in the 2^{nd} heating procedure with integration of the melting peak.

In another preferred embodiment, a blend of various polyamides is used as component a.

It is preferable to use aliphatic or semiaromatic polyamide as component a., in particular nylon-6

(PA 6) or nylon-6,6 (PA 66) or a copolyamide of PA6 or PA66. In particular, it is very particularly preferable to use PA 6.

The nomenclature used for the purposes of the present Patent Application for the polyamides corresponds to an international standard where the first numeral(s) state(s) the number of C atoms in the starting diamine and the final numeral(s) state(s) the number of C atoms in the dicarboxylic acid. If only one numeral is stated, as in the case of PA 6, this means that the starting material was an α,ω-aminocarboxylic acid or the lactam derived therefrom, i.e. ε-caprolactam in the case of PA 6; for further information reference may be made to H. Domininghaus, Die Kunststoffe und ihre Eigenschaften [Plastics and their properties], pp. 272 ff., VDI-Verlag, 1976.

It is preferable to use, as component a., a polyamide with viscosity number, determined in 0.5% by weight solution in 96% by weight sulphuric acid at 25° C. in accordance with ISO 307, of from 80 to 170 ml/g, particularly from 90 to 150 ml/g, very particularly from 90 to 130 ml/g, more particularly from 95 to 120 ml/g.

In one particularly preferred embodiment, a nylon-6 with viscosity number, determined in 0.5% by weight solution in 96% by weight sulphuric acid at 25° C. in accordance with ISO 307, of from 95 to 120 ml/g is used as component a.

The polyamides to be used in the thermoplastic moulding compositions of the invention can be produced by various processes, and can be synthesized from various units. There are many known procedures for the production of polyamides, using different monomer units, and also different chain regulators to establish a desired molecular weight, or else monomers having reactive groups for posttreatments subsequently envisaged, as required by the desired final product.

The industrially relevant processes for the production of the polyamides to be used in the invention mostly proceed by way of polycondensation in the melt. For the purposes of the present invention, the hydrolytic polymerization of lactams is also regarded as polycondensation.

Polyamides to be used with preference in the invention are semicrystalline polyamides, where these are produced by starting from diamines and dicarboxylic acids and/or lactams having at least 5 ring members, or from corresponding amino acids. Starting materials that can be used are preferably aliphatic and/or aromatic dicarboxylic acids, particularly preferably adipic acid, 2,2,4-trimethyladipic acid, 2,4,4-trimethyladipic acid, azelaic acid, sebacic acid, isophthalic acid, terephthalic acid, aliphatic and/or aromatic diamines, particularly preferably tetramethylenediamine, hexamethylenediamine, 2-methylpentane-1,5-diamine, 1,9-nonanediamine, 2,2,4- and 2,4,4-trimethylhexamethylenediamine, the isomers diaminodicyclohexylmethane, diaminodicyclohexylpropane, bisaminomethylcyclohexane, phenylenediamine, xylylenediamine, aminocarboxylic acids, in particular aminocaproic acid, or the corresponding lactams. Copolyamides of a plurality of the monomers mentioned are included.

Polyamides to be used with particular preference as component a. in the invention are produced from caprolactam, very particularly preferably from ε-caprolactam.

In particular, particular preference is moreover given to most of the compounded materials based on PA 6 and PA 66, and to other compounded materials based on aliphatic or/and l5 aromatic polyamides and, respectively, copolyamides, where for each polyamide group in the polymer chain of the compounded material there are from 3 to 11 methylene groups.

The moulding compositions of the invention comprise, as component b., from 30 to 80% by weight of the triclinic pinacoidal form of aluminium silicate.

The mineral to be used for the purposes of the present invention is the triclinic pinacoidal form of Al₂O₃SiO₂, which can comprise compounds of iron and/or of chromium as contaminants. It is preferable in the invention to use kyanite, i.e. the triclinic pinacoidal form of Al₂O₃SiO₂ comprising less than 1% by weight, particularly preferably less than 0.5% by weight, of contaminants.

It is preferable that the triclinic pinacoidal form of aluminium silicate is used as powder. The median particle size d₅₀ of preferred powders is at most 500 μm, preferably from 0.1 to 250 μm, particularly preferably from 0.5 to 150 μm, very particularly preferably from 0.5 to 70 μm, in accordance with ASTM D1921-89, Test Method A—this test method uses multiple sieves selected to span the particle size of the materialand to determine the mean particle diameter and particle size distribution—, thus ensuring fine dispersion in the thermoplastic or in the mixtures and thermoplastic moulding compositions of the invention.

The aluminium silicate particles to be used in the invention in the triclinic pinacoidal form can have various shapes, which can be described via the aspect ratio. It is preferable to use particles with an aspect ratio of from 1 to 100, particularly from 1 to 30, very particularly from 1 to 10.

The triclinic pinacoidal aluminium silicate particles to be used in the invention, also termed kyanite particles, can be used with or without surface modification. The expression surface modification means organic coupling agents which are intended to improve coupling to the thermoplastic matrix. It is preferable to use amino silanes or epoxy silanes as surface modification. In one preferred embodiment, the kyanite particles to be used in the invention are used without surface modification. An example of a supplier of kyanite is Quarzwerke GmbH, Frechen, a company that markets kyanite as Al₂O₃SiO₂ with trade mark Silatherm®.

The moulding compositions of the invention comprise, as component c., at least one heat stabilizer.

Preferred heat stabilizers are substances selected from the group consisting of sterically hindered phenols, sterically hindered phosphites, sterically hindered phosphates, hydroquinones, aromatic secondary amines, substituted resorcinols, salicylates, benzotriazoles or benzophenones, or copper halides, optionally in combination with alkali metal halides and/or with alkaline earth metal halides, or else manganese chloride, and also variously substituted representatives of all of the abovementioned compounds and mixtures of these. The expression steric hindrance means in organic chemistry the effect of the three-dimensional size of a molecule on the progress of a reaction. The expression was coined by Victor Meyer in 1894, and describes the observed phenomenon that the presence of large and bulky groups in the environment of the reacting atoms causes some reactions to proceed only very slowly, or not to proceed at all. A known example of the effect of steric hindrance is the reaction of ketones in a Grignard reaction. If di-tert-butyl ketone is used in the reaction, the very bulky tert-butyl groups retard the reaction so greatly that at most a methyl group can be introduced, and larger moieties do not react at all. Another observable effect of steric hindrance is the hindrance of rotation around a single C—C bond within a molecule.

Particularly preferred heat stabilizers are substances from the group of the sterically hindered phenols and of the sterically hindered phosphites or copper halides, optionally in combination with alkali metal halides and/or with alkaline earth metal halides. Preferred alkali metal compounds and/or alkaline earth metal compounds are potassium iodide, potassium bromide, sodium chloride and calcium chloride. However, in a preferred embodiment, it is also possible to use manganese chloride in combination with the heat stabilizers listed above.

Heat stabilizers used with very particular preference are sterically hindered phenols and/or phosphites, and in particular sterically hindered phenols are used with particular preference. In particular, very particular preference is given to use of the sterically hindered phenol N,N′-hexamethylenebis[3-(3,5-di-tert-butyl-4-hydroxyphenyl)]propionamide (CAS No.: 23128-74-7) as heat stabilizer c., this compound being supplied by BASF SE, Ludwigshafen with trade mark Irganox® 1098.

Other additional substances as component d. for the purposes of the present invention are preferably substances from the group of UV stabilizers, gamma-radiation stabilizers, hydrolysis stabilizers, antistatic agents, emulsifiers, nucleating agents, plasticizers, processing aids, impact modifiers or elastomer modifiers, fillers and reinforcing materials, lubricants, mould-release agents, dyes and pigments. The additives mentioned, and other suitable additives, are prior art and can be found by the person skilled in the art by way of example in Plastics Additives Handbook, 5th Edition, Hanser-Verlag, Munich, 2001, pp. 80-84, 546-547, 688, 872-874, 938, 966. The additional substances to be used as component d. can be used alone or in a mixture or in the form of masterbatches.

UV stabilizers to be used with preference as additional substance in the invention are substituted resorcinols, salicylates, benzotriazoles or benzophenones.

The impact modifiers or elastomer modifiers to be used with preference as component d. in the invention are very generally copolymers preferably composed of at least two of the following group of monomers: ethylene, propylene, butadiene, isobutene, isoprene, chloroprene, vinyl acetate, styrene, acrylonitrile and acrylates or methacrylates having from 1 to 18 C atoms in the alcohol component. The copolymers can comprise compatibilizing groups, preferably maleic anhydride or epoxide.

Dyes or pigments to be used with preference as colorant additional substance in the invention are inorganic pigments, particularly titanium dioxide, ultramarine blue, iron oxide, zinc sulphide or carbon black, or else organic pigments, particularly phthalocyanines, quinacridones, perylenes or else dyes, particularly nigrosin or anthraquinones, or else other colorants.

Nucleating agents to be used with preference as additional substance in the invention are sodium or calcium phenylphosphinate, aluminium oxide or silicon dioxide or Mg₃[Si₄O₁₀(OH)₂], particularly Mg₃[Si₄O₁₀(OH)₂] powder, more particularly preferred microtalc [CAS No. 14807-96-6].

Preferably microcrystalline talc is used. According to the invention a microcrystalline talc has an average diameter d₅₀ equal to or less than 4.5 microns. It is a microcrystalline talc having preferably an average diameter d₉₅ equal to or less than 15 microns. The average diameter d₅₀ is a diameter at which 50 wt. % of particles have a size of less than the diameter as indicated; d₉₅ sectional diameter is a diameter in which 95 wt. % of the particles have a size of less than the diameter as indicated. For non-spherical particles, the size is determined by the equivalent spherical diameter (Stokes diameter). All these d₅₀ and d₉₅ diameters are measured according to AFNOR X11-683 with a device “SEDIGRAPH”™. Standard talc has a d₅₀ in the order of 8 to 15 microns.

Lubricants and/or mould-release agents to be used with preference as additional substance in the invention are long-chain fatty acids, in particular stearic acid, salts thereof, in particular Ca stearate or Zn stearate, or else ester derivatives or amide derivatives thereof, in particular ethylenebisstearylamide, glycerol tristearate, stearyl stearate, montan waxes, in particular esters of montanic acids with ethylene glycol, or else oxidized or unoxidized low-molecular-weight polyethylene waxes or oxidized or unoxidized low-molecular-weight polypropylene waxes. Lubricants and/or mould-release agents particularly preferred in the invention are found in the group of the esters or amides of saturated or unsaturated aliphatic carboxylic acids having from 8 to 40 C atoms with saturated aliphatic alcohols or amines having from 2 to 40 C atoms. In another preferred embodiment, the moulding compositions of the invention comprise mixtures of the abovementioned lubricants and/or mould-release agents. The montan wax esters and salts thereof to be used with particular preference improve the flowability of plastics such as polyamides solely via internal lubricant action, without reducing the molecular weight of the polymer. In particular, it is very particularly preferable to use esters of montanic acid with polyhydric alcohols that are supplied by Clariant GmbH, with trade mark Licowax® E [CAS No. 73138-45-1].

Fillers and reinforcing materials to be used with preference as additional substance in the invention are fibrous, acicular or particulate fillers and reinforcing materials different from component b., the kyanite. Particular preference is given to carbon fibres, glass beads, amorphous silica, calcium silicate, calcium metasilicate, magnesium carbonate, kaolin, calcined kaolin, chalk, powdered quartz, mica, phlogopite, barium sulphate, feldspar, wollastonite, montmorillonite or glass fibres, and very particular preference is given to glass fibres, in particular glass fibres made of E glass. In one preferred embodiment, the fibrous or particulate reinforcing materials have been provided with suitable surface modifications, in particular surface modifications comprising silane compounds, in order to improve compatibility with thermoplastics.

In particular, preferred additional substance for the purposes of the present invention is talc powder. The mineral talc, or in pulverized form talc powder, is a magnesium silicate hydrate with the chemical composition Mg₃[Si₄O₁₀(OH)₂].

Preference is therefore given in the invention to mixtures comprising
a. polyamide, preferably PA 6,
b. triclinic pinacoidal aluminium silicate,
c. N,N′-hexamethylenebis[3-(3,5-di-tert-butyl-4-hydroxyphenyl)]propionamide, and also
d. Mg₃[Si₄O₁₀(OH)₂].

Particular preference is given in the invention to mixtures comprising
a. from 5 to 69.94% by weight of polyamide,
b. from 30 to 80% by weight of triclinic pinacoidal aluminium silicate,
c. from 0.05 to 5% by weight of N,N′-hexamethylenebis[3-(3.5-di-tert-butyl-4-hydroxyphenyl)]propionamide, and
d. from 0.01 to 60% by weight of at least Mg₃[Si₄O₁₀(OH)₂], where the sum of all the percentages by weight is always 100% by weight.

Preference is even given in the invention to mixtures comprising
a. polyamide, preferably PA 6,
b. triclinic pinacoidal aluminium silicate,
c. N,N′-hexamethylenebis[3-(3,5-di-tert-butyl-4-hydroxyphenyl)]propionamide,
d. Mg₃[Si₄O₁₀(OH)₂] and esters of montanic acid with polyhydric alcohols.

Particular preference is even given in the invention to mixtures comprising
a. from 5 to 69.94% by weight of polyamide, preferably PA 6,
b. from 30 to 80% by weight of triclinic pinacoidal aluminium silicate,
c. from 0.05 to 5% by weight of N,N′-hexamethylenebis[3-(3.5-di-tert-butyl-4-hydroxyphenyl)]propionamide, and
d. from 0.01 to 60% by weight of at least Mg₃[Si₄O₁₀(OH)₂] and esters of montanic acid with polyhydric alcohols, where the sum of all the percentages by weight is always 100% by weight.

The present invention further provides mixtures of triclinic pinacoidal aluminium silicate with at least one component selected from the group of N,N′-hexamethylenebis[3-(3,5-di-tert-butyl-4-hydroxyphenyl)]propionamide, Mg₃[Si₄O₁₀(OH)₂] and at least one ester of montanic acid with polyhydric alcohols.

The present invention further provides in a preferred embodiment even mixtures of triclinic pinacoidal aluminium silicate and N,N′-hexamethylenebis[3-(3,5-di-tert-butyl-4-hydroxyphenyl)]propionamide, mixtures of triclinic pinacoidal aluminium silicate and Mg₃[Si₄O₁₀(OH)₂], and mixtures of triclinic pinacoidal aluminium silicate and at least one ester of montanic acid with polyhydric alcohols.

Process The present invention further provides a process for the production of the mixtures of the invention, where components a. to d. are mixed or combined in appropriate proportions by weight.

The present invention further provides a process for the production of thermoplastic moulding compositions in which the mixtures of the invention are kneaded, compounded, extruded or rolled, preferably at a temperature of from 220 to 400° C., particularly preferably via compounding in a corotating twin-screw extruder or Buss kneader.

It can be advantageous to premix individual components.

The present Patent Application also provides the use, in the extrusion process, in blow-moulding processes or in injection moulding, of the thermoplastic moulding compositions to be produced from the mixtures of the invention, for the production of products, preferably of mouldings or semifinished products.

Processes of the invention for the production of products by means of extrusion, blow moulding or injection moulding operate with melt temperatures in the range from 230 to 330° C., preferably from 250 to 300° C., and also optionally at pressures of at most 2500 bar, preferably at pressures of at most 2000 bar, particularly preferably at pressures of at most 1500 bar and very particularly preferably at pressures of at most 750 bar.

In extrusion, thermoplastic moulding compositions in solid to high-viscosity liquid form, which can be hardened, are extruded continuously under pressure from a shaping aperture (also termed die, female mould or die ring). This gives products with the cross section of the aperture and, in theory, any desired length (http://de.wikipedia.orgiwiki/Extrusion_(Verfahrenstechnik [Process technology])). The fundamental steps of the profile extrusion process, which is a form of the extrusion process, are:
1. plastification and provision of the thermoplastic melt in an extruder,
2. extrusion of the thermoplastic melt strand through a calibrating sleeve which has the cross section of the profile to be extruded,
3. cooling of the extruded profile in a calibrating table,
4. onward transport of the profile by a take-off behind the calibrating table,
5. cutting of the previously continuous profile to length in a cutter,
6. collection of the cut-to-length profiles at a collection table.

Kunststoff-Handbuch 3/4, Polyamide [Plastics Handbook 3/4, Polyamides], Carl Hanser Verlag, Munich 1998, pp. 374-384 provides a description of the profile extrusion process for nylon-6 and nylon-6,6.

The blow-moulding process is described by way of example at http://www.blasformen.com/. In the first step of the blow-moulding process a heated extruder is used for input, compaction, devolatilization, heating and plastification of plastics pellets, and for homogenization of these to give a plastic polymer strand.

In the next step the plastics composition is passed into a parison die flanged onto the extruder.

Here, the plastics melt is moulded to give a parison, which emerges vertically downwards from the die. The diameter of the parison is adjusted to be appropriate to the finished item by using variously dimensioned standard mandrel units and standard die units, flanged onto the parison die. The thickness of the parison and the resultant weight of the blow mouldings is predetermined via the selection of various diameter differences between mandrel and die.

A feature of the injection-moulding process is that the raw material, i.e. the thermoplastic moulding composition to be processed, comprising the mixtures of the invention, preferably in pellet form, is melted (plastified) in a heated cylindrical cavity and, in the form of injection-moulding composition, is injected under pressure into a temperature-controlled cavity. After the composition has cooled (solidified), the injection moulding is demoulded.

The various stages are
1. plastification/melting
2. injection phase (charging procedure)
3. hold-pressure phase (to take account of thermal contraction during crystallization)
4. demoulding.

An injection-moulding machine is composed of a clamping unit, the injection unit, the drive and the control system. The clamping unit has fixed and movable platens for the mould, an end platen, and also tie bars and drive for the movable mould platen. (Toggle assembly or hydraulic clamping unit.)

An injection unit comprises the electrically heatable cylinder, the screw drive (motor, gearbox) and the hydraulic system for displacing the screw and injection unit. The function of the injection unit consists in melting, metering and injecting the powder or the pellets and applying hold pressure thereto (to take account of contraction). The problem of reverse flow of the melt within the screw (leakage flow) is solved via non-return valves.

Within the injection mould, the inflowing melt is then separated and cooled, and the required component is thus manufactured. Two mould halves are always needed for this purpose. The various functional systems used in injection moulding are:
runner system
shaping inserts
venting
machine mounting and uptake of force
demoulding system and transmission of motion
temperature control.

In contrast to injection moulding, the extrusion process uses, in the extruder, a continuously shaped strand made of the thermoplastic moulding composition of the invention, the extruder being a machine for the production of products based on thermoplastic moulded sections. Various types of equipment are

Single-screw extruders and twin-screw extruders, and also the respective subgroups: conventional single-screw extruders, conveying single-screw extruders, contrarotating twin-screw extruders and corotating twin-screw extruders.

Extrusion plants for the production of profiles are composed of: extruder, profile die, calibrating system, cooling section, caterpillar take-off and roller take-off, separation device and tilting chute.

The present invention accordingly also provides products, preferably mouldings, moulded bodies or semifinished products, obtainable via extrusion or injection moulding of the thermoplastic moulding compositions of the invention.

### Method of Use

However, the present invention also provides the use of electrically insulating but thermally conductive products, preferably mouldings, moulded bodies or semifinished products, obtainable via extrusion, profile extrusion, blow moulding or injection moulding of the mixtures of the invention.

The present invention preferably provides the use for electrical or electronic components of the electrically insulating but thermally conductive products produced via extrusion or injection moulding, preferably mouldings, moulded bodies or semifinished products. These products of the invention can preferably be used in the motor vehicle industry or in the electrical industry, electronics industry, telecommunications industry, solar industry, information-technology or computer industry, in households, in sports, in medicine or in the consumer-electronics industry.

In particular, products of the invention can be used for applications which require improved conduction of heat and good mechanical properties. For applications of this type preference is given to the use for mouldings in vehicles, in particular in motor vehicles (MVs).

The present invention therefore also provides the use of the thermoplastic moulding compositions of the invention for the production of mouldings and semifinished products and in turn the use of products to be produced therefrom, where these have increased thermal conductivity, preference being given to the production of mouldings for motor vehicles.

However, the present invention also provides the use of aluminium silicate, preferably Al₂O₃SiO₂, particularly preferably of triclinic pinacoidal aluminium silicate, which is kyanite, for improving the thermal conductivity of polyamide-based products with retention of the mechanical properties and the electrically insulating properties of the polyamide.

However, the present invention also provides the use of triclinic pinacoidal aluminium silicate Al₂O₃SiO₂ in mixtures for thermoplastic moulding compositions.

It will be understood that the specification and examples are illustrative but not !imitative of the present invention and that other embodiments within the spirit and scope of the invention will suggest themselves to those skilled in the art.

### EXAMPLES

The individual components a., b., c. and d. were mixed at a temperature of about 280° C. in a ZSK 26 Compounder twin-screw extruder from Coperion Werner & Pfleiderer (Stuttgart,

Germany), discharged as strand into a water bath, cooled until pelletizable and pelletized. The pellets were dried to constant weight in a vacuum drying cabinet at 70° C.

The pellets were then processed in an Arburg SG370-173732 injection-moulding machine at melt temperatures of from 270 to 300° C. and mould temperatures of from 80 to 100° C. to give dumbbell specimens (thickness 4 mm in accordance with ISO 528) and plaques of dimensions 60 mm 40 mm 2 mm. The plaques were then milled to the dimensions 12.7 mm 12.7 mm 2 mm.

The mechanical properties of the products produced from the thermoplastic moulding compositions of the invention were determined in the ISO 527 tensile test.

Thermal conductivity was determined on plaques of dimensions 12.7 mm 12.7 mm 2 mm in accordance with ISO 22007-4.

All of the compositions shown in the table below were processed in the manner described above.

| | Inv. Ex. 1 | Inv. Ex. 2 | Comp. Ex. 1 |
|---|---|---|---|
| Nylon-6 | 34.29 | 24.29 | 34.90 |
| Aluminium silicate | 65.00 | 75.00 | |
| Montan wax ester | 0.20 | 0.20 | 0.10 |
| Heat stabilizer | 0.50 | 0.50 | |
| Microtalc powder | 0.01 | 0.01 | |
| Aluminium oxide | | | 50.00 |
| Graphite | | | 15.00 |
| Thermal conductivity [W/mK] | 1.01 | 1.53 | 1.67 |
| Breaking stress [MPa] | 89.00 | 91.00 | 60.00 |
| Tensile strain at break [%] | 4.00 | 1.90 | 0.70 |
| Tensile modulus [MPa] | 9124.00 | 13725.00 | 9805.00 |

### Materials Used:

Nylon-6, linear with viscosity number 107 ml/g, determined in 0.5% by weight solution in: 96% by weight sulphuric acid at 25° C. in accordance with ISO 307
Kyanite, e.g. Silatherm®-T 1360-400 AST from Quarzwerke GmbH
Montan wax ester, e.g. Licowax® E from Clariant GmbH [CAS No.73138-45-1]
Heat stabilizer, e.g. Irganox® 1098 from BASF SE
Mg₃[Si₄O₁₀(OH)₂] Talc powder , Mistron® Vapor R, Imerys Talc America
Aluminium oxide, e.g. Martoxid® MPS2 from Martinswerk GmbH
Graphite, e.g. EG32 special graphite from SGL Carbon GmbH

The thermoplastic moulding compositions of the invention, based on polyamide, or specimens made therefrom, therefore exhibit high thermal conductivity together with electrically insulating properties and good mechanical properties, in that there is a significant reduction of the wear known to be caused by aluminium oxide (Comp. ex) on the equipment used in the processing of compounded polyamide materials comprising mixtures of the invention.

1. A mixture comprising:
a. from 5 to 69.94% by weight of polyamide,
b. from 30 to 80% by weight of triclinic pinacoidal aluminium silicate,
c. from 0.05 to 5% by weight of at least one heat stabilizer, and
d. from 0.01 to 60% by weight of at least one additional substance,
where the sum of all of the percentages by weight is always 100% by weight.

2. The mixture according to claim 1 wherein component d. comprises Mg₃[Si₄O₁₀(OH)₂] and optionally at least one other additional substance.

3. The mixture according to claim 1, wherein component d. comprises Mg₃[Si₄O₁₀(OH)₂], esters of montanic acid with polyhydric alcohols.

4. A thermoplastic moulding composition comprising the mixture according to claim 1, wherein the mixture makes up from 95 to 100% by weight of the thermoplastic moulding composition.

5. The thermoplastic moulding composition according to claim 4, wherein the polyamide is an amorphous or semicrystalline polyamide and the enthalpy of fusion of semicrystalline polyamides is from 4 to 25 J/g, measured by the DSC method in accordance with ISO 11357 in the 2^{nd} heating procedure with integration of the melting peak, and the enthalpy of fusion of amorphous polyamides is less than 4 J/g, measured by the DSC method in accordance with ISO 11357 in the 2^{nd} heating procedure with integration of the melting peak.

6. The thermoplastic moulding composition according to claim 5, wherein the polyamide is nylon-6 or nylon-6,6.

7. The thermoplastic moulding composition according to claim 6, wherein the polyamide is nylon-6.

8. The thermoplastic moulding composition according to claim 4, wherein the viscosity number of the polyamide, measured in 96% sulphuric acid in accordance with DIN ISO 307, is from 80 to 170 ml/g.

9. The thermoplastic moulding composition according to claim 8 wherein the viscosity number of the polyamide is from 90 to 150 ml/g.

10. The thermoplastic moulding composition according to claim 4, wherein component c is selected from the group consisting of sterically hindered phenols, sterically hindered phosphites, sterically hindered phosphates, hydroquinones, aromatic secondary amines, substituted resorcinols, salicylates, benzotriazoles or benzophenones, copper halides, optionally in combination with alkali metal halides and/or with alkaline earth metal halides, and substituted representatives of all of the abovementioned compounds and mixtures thereof.

11. The thermoplastic moulding composition according to claim 10, wherein component c is N,N′-hexamethylenebis[3-(3,5-di-tert-butyl-4-hydroxyphenyl)]propionamide.

12. The thermoplastic moulding composition according to claim 4, wherein component d is selected from the group consisting of UV stabilizers, gamma-radiation stabilizers, hydrolysis stabilizers, antistatic agents, emulsifiers, nucleating agents, plasticizers, processing aids, impact modifiers or elastomer modifiers, fillers and reinforcing materials, lubricants, mould-release agents, dyes, pigments, and mixtures thereof.

13. The thermoplastic moulding composition according to claim 4, wherein the mixture comprises a. polyamide, b. triclin pinacoidal aluminium silicate, c. at least one substance selected from the group consisting of sterically hindered phenols, sterically hindered phosphites, sterically hindered phosphates, hydroquinones, aromatic secondary amines, substituted resorcinols, salicylates, benzotriazoles or benzophenones, copper halides, optionally in combination with alkali metal halides and/or with alkaline earth metal halides, and also substituted representatives of all of the abovementioned compounds and mixtures thereof, and d. Mg₃[Si₄O₁₀(OH)₂].

14. The thermoplastic moulding composition according to claim 13, wherein the polyamide is nylon-6 or nylon-6,6.

15. The thermoplastic moulding composition according to claim 14, wherein the polyamide is nylon-6.

16. The thermoplastic moulding composition according to claim 13, wherein component d. additionally comprises esters of montanic acid with polyhydric alcohols.

17. A process for the production of the mixtures according to claim 1, wherein components a. to d. are mixed or combined in appropriate proportions by weight.

18. A process for the production of the thermoplastic moulding compositions according to claim 4, wherein the mixture is kneaded, compounded, extruded, or rolled, at a temperature of from 220 to 400° C.

19. A product obtained by extrusion, blow moulding or injection moulding of the thermoplastic moulding compositions according to claim 4.

20. The product according to claim 19 wherein the product is a moulding or a semifinished product.

21. A method for improving the thermal conductivity of polyamide-based products with retention of both the mechanical properties and the electrically insulating properties of the polyamide the method comprising adding triclinic pinacoidal aluminium silicate to the polyamide based product.

22. The method according to claim 21, further comprising using the aluminium silicate-polyamide-based product in mixtures for thermoplastic moulding compositions.

23. The method according to claim 22, further comprising extruding, blow-moulding, or injection moulding of the thermoplastic moulding compositions for the production of products

24. The method according to claim 23, wherein the products are mouldings or semifinished products.

25. The method according to claim 23, wherein the products, mouldings or semifinished products are used for the production of items for the electrical industry, electronics industry, telecommunications industry, information-technology, solar industry or computer industry, for households, for sports, for medical applications or for the consumer-electronics industry or in motor vehicles.

26. A mixture comprising triclinic pinacoidal aluminium silicate with at least one component selected from the group of N,N′-hexamethylenebis[3-(3,5-di-tert-butyl-4-hydroxyphenyl)]propionamide, Mg₃[Si₄O₁₀(OH)₂] and at least one ester of montanic acid with polyhydric alcohols.
